(19) United States
(12) Patent Application Publication
(10) Pub. No.: US 2010/0078300 A1
(43) Pub. Date: Apr. 1, 2010

(54) Circuit Breaker

(75) Inventors: Karsten Freundt, Falkensee (DE); Karl-Heinz Voss, Dallgow-Doberitz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/063,484

(22) PCT Filed: Aug. 10, 2005
(86) PCT No.: PCT/DE2005/001434

§ 371 Date: Feb. 11, 2008

(51) Int. Cl. H01H 25/00

(52) U.S. Cl. 200/337

(57) ABSTRACT

A circuit breaker has at least one pole arrangement with a movable contact. A twin-armed lever is pivotally mounted for opening and closing the movable contact. A switch-on energy storage device is provided and a cam disc that is coupled to the switch-on energy storage device and, via an actuating element, to a first end of the lever. The second end of the lever is connected to the movable contact piece of the pole arrangement. There is also provided at least one switch-off energy storage device. The circuit breaker has a simple and compact design. The actuating element is a switching shaft, which interacts with the cam disc, is mounted such that it can rotate and is connected to the first end of the twin-armed lever via the switch-off energy storage device.

The invention relates to a circuit breaker with at least one pole arrangement, which comprises a movable contact, with a rotatably mounted twin-armed lever for opening and closing the movable contact, a switch-on energy store, and with a cam disk, which is coupled to the switch-on energy store and, via an actuating element, to a first end of the lever, the second end of the lever being connected to the movable contact piece of the pole arrangement, and with at least one switch-off energy store.

A circuit breaker of this type is known from DE 4 138 333 C2. In the case of this switch, a rotatably mounted twin-armed lever has, at a first end facing the cam element/the cam disk, an actuating element in the form of a rotatably mounted roller, which interacts with the cam element, the cam element being set in rotation by the energy stored in a spring element as the switch-on energy store. A movable contact is arranged such that it is capable of moving relative to a fixed contact by means of the second end of the rotatably mounted twin-armed lever between an open state and a closed state of the switch. The arrangement comprising the spring element and the cam element is in this case arranged on a movable supporting device in such a way that it can swivel, a locking device being provided for latching in and releasing the movable supporting device. Switch-off energy store means, which absorb energy during a switch-on operation which is used for switching off the switch, are connected to the twin-armed lever at its first end. Such an arrangement has a complicated and involved design since, for example, in order to open the movable contact, the rotatably mounted supporting elements with the cam elements arranged thereon need to be swiveled in order to make it possible to disconnect the contacts. Such a design in particular takes up a large volume.

The object of the present invention is to design a circuit breaker of the type mentioned at the outset which has a simple and compact design.

According to the invention, the object is achieved by virtue of the fact that the actuating element is a rotatably mounted switching shaft, which can be controlled by the cam disk and is connected to the first end of the twin-armed lever via the switch-off energy store. In such an arrangement, the energy of the switch-on energy store is transmitted via the switching shaft as the actuating element and the switch-off energy store to the lever for closing the movable contact, as a result of which a compact design is made possible.

In a preferred embodiment, in the case of a multi-pole pole arrangement, the switching shaft extends over the entire pole arrangement and has a driver for each movable contact, on which driver a first end of the respective switch-off energy store is arranged in articulated fashion. It is advantageous in the case of such a switching shaft that, by means of the respective driver in the case of a multi-pole pole arrangement, for example in the case of a three-pole circuit breaker, the energy of the switch-on energy store can be transmitted to the respective movable contact by the switching shaft, so that synchronous driving of the entire pole arrangement is ensured without a complex holding system for a transverse rod.

In a further configuration of the invention, the switch-off energy store is connected at a second end to the first end of the twin-armed lever in articulated fashion. The articulated arrangement of the switch-off energy store between the switching shaft and the twin-armed lever makes it possible for the switch-off energy store in its tensioned state to be located virtually in an extended position with respect to a line between the pivot of the switching shaft and the second end of the switch-off energy store. As a result, only a low torque is exerted on the switching shaft, with the result that the latter can be fixed in a simple manner, the torque exerted by the switch-off energy store being sufficient for disconnecting the contact when the fixing of the switching shaft has been released.

In an expedient development, the switch-off energy store comprises a spring element. Such a switch-off energy store, in the arrangement according to the invention, makes simple tensioning of the switch-off energy store possible during the switch-on operation.

In a preferred embodiment, the switch-on energy store comprises a spring element, which is mounted at a first end on a housing part and is coupled at a second end to the cam disk via a tensioning shaft. Such an arrangement firstly makes it possible for the energy of the switch-on store to be transmitted in a simple manner by means of the cam disk to the lever, and secondly energy can be supplied to the switch-on energy store in a simple manner via a drive unit, which is connected to the tensioning shaft.

In a preferred embodiment, the switch-on energy store is held at a first end and is connected at a second end to an eccentric of a tensioning apparatus, with which return movement-limiting means interact, and the means have a catch mechanism, which is arranged at the first end of the switch-on energy store. Such an arrangement is advantageously simple, cost-effective and at the same time low in wear because a return movement of the switch-on energy store is limited or prevented merely by the catch mechanism, which is arranged at the first end of the switch-on energy store.

In an expedient development, the means contain a guide part, which triggers the catch mechanism, with which the first end of the switch-on energy store is mounted movably on a fixed spindle by means of a slot formed in the guide part, and which is connected to the second end of the switch-on energy store. It is advantageous with such an arrangement that, as a result of the eccentrically mounted second end of the switch-on energy store and the guide part, which is mounted in a slot, a movement part of the guide part as regards it free end during a switch-on operation differs from a movement path after the switch-on operation, with the result that, with the catch mechanism, on the one hand tensioning of the switch-on energy store takes place and, on the other hand, a return movement is limited.

In a preferred embodiment, the catch mechanism has a catch, which is capable of moving rotatably about the fixed spindle between a first and a second position and on which a spring element acts. With such a catch, the catch mechanism can have a simple design.

In a preferred embodiment, the fixed spindle and the spring element are held on a fastening element. With such an arrangement, the catch can be swiveled about the spindle by means of the spring element in a simple manner between its first and its second position.

In an expedient configuration, a stop element, which interacts with a tensioning cutout on the catch, is provided on the guide part. As a result of the arrangement of the stop element on the guide part and the interaction with the tensioning cutout, a simple possibility for the deflection of the catch out of its first position into its second position is realized.

In a further development, the catch has a checking cutout. In the event of a return movement of the switch-on energy store after a switch-on operation, the stop element engages in the checking cutout, so that a return movement limitation is formed in a simple and effective manner.

In a further preferred embodiment, in the case of the tensioning apparatus for the switch-on energy store, the tensioning shaft, which can be rotated by means of a drive wheel, for tensioning the switch-on energy store is fixedly connected in each case to an eccentric and to a cam disk and has a triggering stop, the drive wheel being coupled to the tensioning shaft via a clutch, and the clutch being a catch arrangement. As a result of such a catch arrangement, a tensioning apparatus is provided which, in terms of its clutch, advantageously has a simple and at the same time cost-effective design, because the catch arrangement manages with comparatively few component parts. In this case, the catch arrangement alone is used to prevent incorrect loading of the tensioning apparatus from taking place as a result of a further actuation of the drive wheel after a tensioning operation.

In a preferred embodiment, the catch arrangement has a catch, which is arranged rotatably on the drive wheel, and a fixed stop element for controlling the catch is provided. It is advantageous with such an arrangement that it is possible to control the catch and, as a result, to decouple the drive wheel from the tensioning shaft merely as a result of the rotatable arrangement of the catch and the fixed stop element.

In an advantageous configuration, the fixed stop element is arranged in such a way that, when the switch-on energy store is tensioned, the catch releases the tensioning shaft. Such an arrangement provides a simple possible way of decoupling the tensioning shaft from the drive after a tensioning operation when the switch-on energy store is tensioned.

In another advantageous configuration, the catch arrangement has a driver, which is fixedly connected to the tensioning shaft and interacts with the catch. The arrangement of such a driver is a simple and expedient possible way of coupling the drive wheel and the tensioning shaft to one another by means of the catch in order to perform a tensioning operation.

The catch arrangement can be guided with respect to its free end in different ways, for example by means of a guide path which is fixed in position. In an advantageous development, the catch arrangement has a spring element. The provision of a spring element ensures that the catch is held in a position in which it is interacting with the driver during a tensioning operation.

In a further preferred configuration of the invention, a positioning pin is provided on the drive wheel. The provision of such a positioning pin advantageously limits the rotation of the rotatably mounted catch as a result of the force transmitted by the spring element, as a result of which the catch is prevented from wearing as a result of a slipping movement on the tensioning shaft during a rotation for the preparation of a tensioning operation of the circuit breaker.

In a further preferred configuration of the invention, a locking mechanism for preventing the discharge of the switch-on energy store is provided, with a pushbutton, which, in an unlocking position of the locking mechanism, is coupled by means of a force transmission element to a discharge triggering device for discharging the switch-on energy store via an interlocking connection, with the result that a switch-on movement acting on the pushbutton can be introduced into the discharge triggering device for relieving the tension on the switch-on energy store via the force transmission element, the force transmission element being connected to interlocking-connection interruption means, which are designed to move the locking mechanism over into a locking position, in which the interlocking connection is cancelled, the pushbutton and the force transmission element being guided movably in the unlocking position in a common longitudinal direction, with the result that a thrusting movement of the pushbutton can be introduced into the switch-on triggering device via a longitudinal movement of the force transmission element, the force transmission element being mounted in such a way that it can swivel, with the result that, in a locking position, a movement direction of the force transmission element is aligned at an angle to the thrusting movement of the pushbutton, the interlocking-connection interruption means being coupled to the switching shaft of the circuit breaker and/or to a secondary switch.

Advantageously, the force transmission element is not guided such that it is capable of performing a longitudinal movement, but can be removed reliably from the interlocking connection between the pushbutton and the tension-relief triggering device by means of introducing a rotary movement. Furthermore, large linear movements are avoided, with the result that the locking mechanism is both reliable and compact.

In an advantageous configuration, the interlocking-connection interruption means have an angle lever, which is articulated on a pivot, which is fixed in position, and is coupled to a restoring spring at a restoring bearing and is coupled to the force transmission element at a connecting bearing by means of a swiveling lever. In accordance with this expedient development, the movement for swiveling the force transmission element is introduced via an angle lever, as a result of which a multifunctional and at the same time compact locking mechanism is provided.

In accordance with an expedient development in this regard, the angle lever is coupled to a switching shaft of the secondary switch by means of lever kinematics in such a way that, if the secondary switch is in a disconnecting position, the angle lever is swiveled counter to the spring force of a restoring spring and the force transmission element is moved over from the unlocking position into the locking position. In this way, the secondary switch can be coupled to the locking mechanism in such a way that, if the secondary switch is located in a disconnecting position, a discharge of the switch-on energy store and therefore connection of the switch, which is a circuit breaker, for example, is made impossible. The coupling between the force transmission element and the secondary switch takes place via expedient lever kinematics and via the angle lever already described. In this case, the force transmission element is mechanically coupled to the drive spindle of the secondary switch. Undesired triggering of the switch, such as for example of a circuit breaker, in the case of an open secondary switch, i.e. a secondary switch which is located in the disconnecting position, which secondary switch is in the form of a switch disconnector, for example, is avoided in this way.

In accordance with an advantageous development of the invention, the angle lever is coupled to a withdrawable-part lock of a withdrawable part by means of lever kinematics in such a way that, if the switch is displaced on the withdrawable part, out of a contact position the angle lever is swiveled counter to the spring force of the restoring spring and the force transmission element is moved over from the unlocking position into the locking position. In accordance with this development of the invention, the lever kinematics are coupled to a withdrawable-part lock. The displacement of a switch on a withdrawable part has, however, the same effect as a separate secondary switch, in particular in the case of air-insulated switches, with the result that the displacement on the withdrawable-part guide is in this case equivalent to the opening of the contacts of a secondary switch and therefore to the coupling to a secondary switch. During the displacement of the switch, for example, contacts which are fixedly connected to the switch are disconnected from contacts which are mounted fixedly on a switchgear assembly. In this case, the switch is mounted movably in the switchgear assembly by means of the withdrawable part.

In accordance with a further expedient development, the angle lever has a driver pin, which extends in a slot of a drive lever, the drive lever at its end remote from the slot being fastened on a cam element of the switching shaft, with the result that, in a switch-position of the switching shaft, the angle lever is swiveled so as to cancel the interlocking connection between the pushbutton and the discharge triggering device. In accordance with this advantageous development, the angle lever and therefore the force transmission element can be coupled to the position of the switching shaft of the circuit breaker, with the result that discharge of the switch-on energy store is made impossible if the contacts of the switch are already located in a contact position. In such a case, no-load switching operation would be triggered, the energy of the switch-on energy store no longer being converted into kinetic energy of the switching mechanism. The switching mechanism is severely loaded by these no-load switching operations, however. It is of course also possible for the angle lever both to be coupled to the switching shaft of the switch or circuit breaker via the drive lever and to be coupled to the secondary switch and/or switch disconnector or else to the lock of a withdrawable part via expedient lever kinematics. The term switch disconnector in such a case also includes a plurality of individual switch disconnectors connected in series. The slot of the drive lever is used for mechanically disconnecting the lock which is triggered by a secondary switch and the lock which is brought about by the switching position of the switch shaft.

In an expedient configuration, the locking mechanism, which can be switched between a locking position, in which the triggering of a switch-on operation with the contacts of the circuit breaker coming into contact with one another is prevented, and an unlocking position, in which the triggering of the switch-on operation is enabled, is linked to a switch-on readiness indicator, and the switch-on readiness indicator is arranged on the circuit breaker in such a way that it can be perceived visually. As a result of a switch-on readiness indicator arranged directly on the circuit breaker, an operator can read the state of the circuit breaker directly on the circuit breaker. Until now, such a readiness indicator on a circuit breaker withdrawable part has been associated with the disadvantage that the state of the circuit breaker has only been queried indirectly via the circuit breaker withdrawable part. It is likewise advantageous that an additional mechanism for an indicator on the circuit breaker withdrawable part is dispensed with.

In a preferred embodiment, the switch-on readiness indicator is mechanical. Such a mechanical switch-on readiness indicator can be linked in a simple manner to the locking mechanism.

In a further preferred embodiment, the switch-on readiness indicator is realized optically. An optical switch-on readiness indicator is an advantageous possible way of visually perceiving the state of the circuit breaker.

The invention will be described in the text which follows using exemplary embodiments with reference to figures in the drawing, in which:

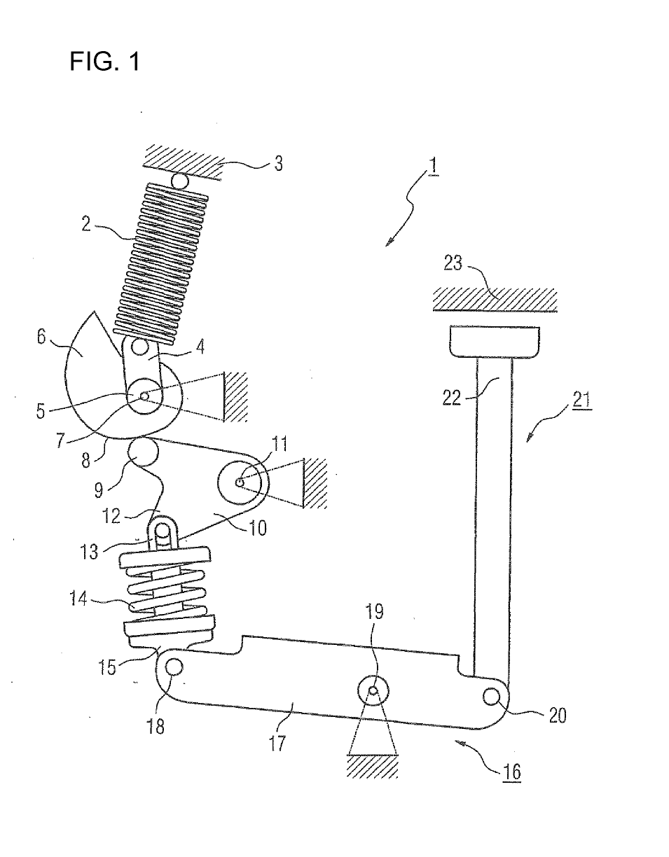

FIG. 1 shows a schematic illustration of the circuit breaker according to the invention in a first position;

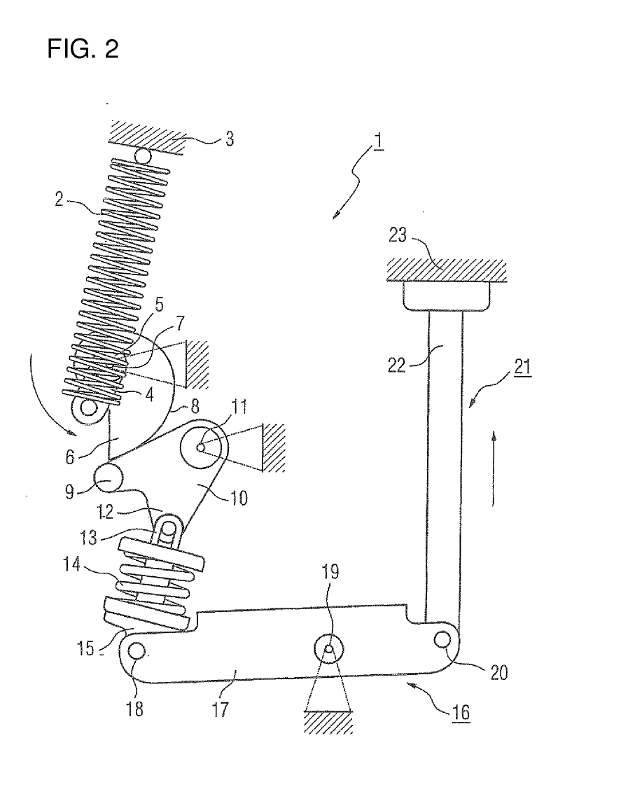

FIG. 2 shows a schematic illustration of the circuit breaker according to the invention in a second position;

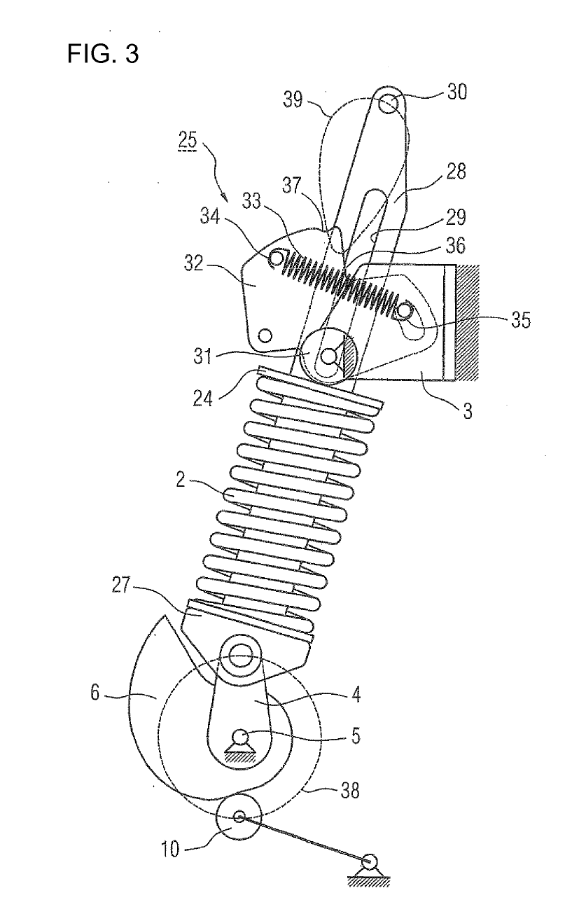

FIG. 3 shows a schematic illustration of a switch-on energy store apparatus in a first position;

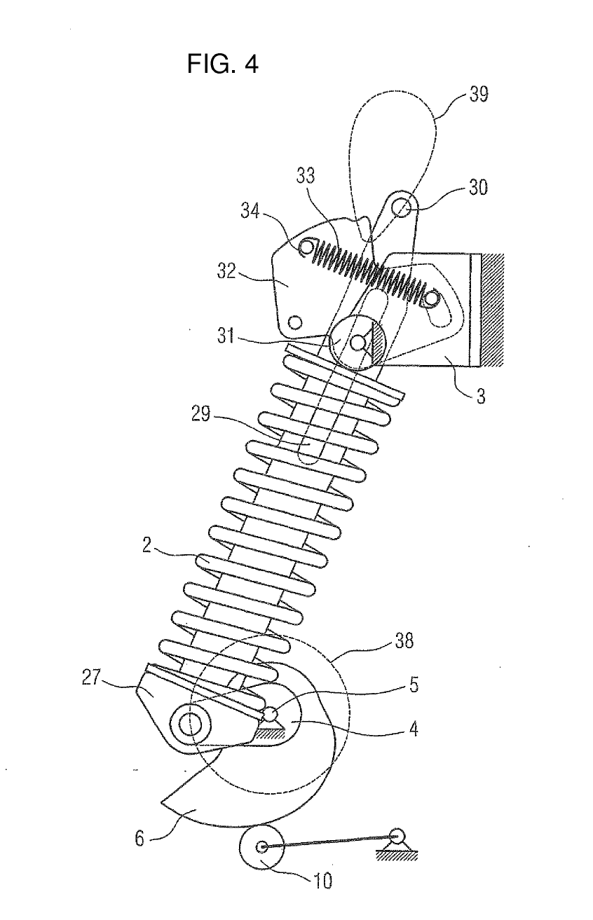

FIG. 4 shows a schematic illustration of the switch-on energy store apparatus in a second position;

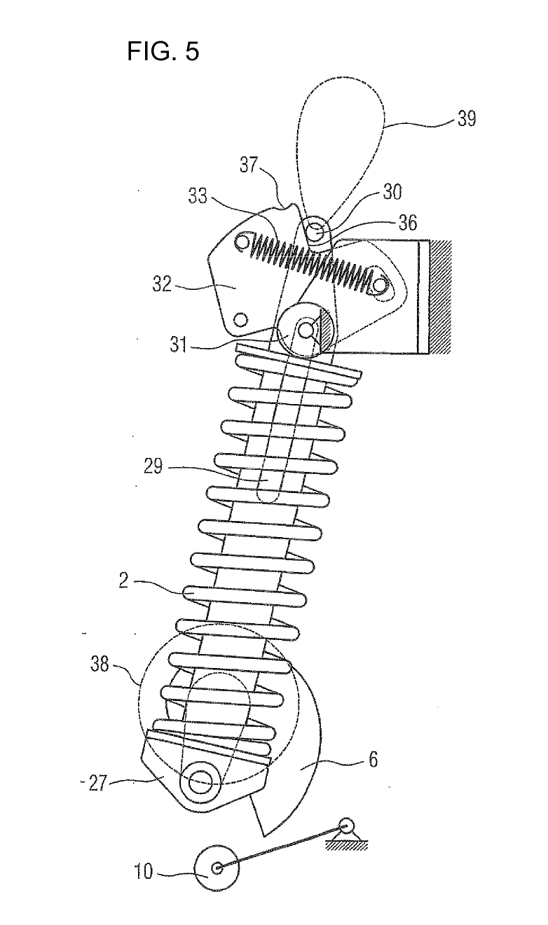

FIG. 5 shows a schematic illustration of the switch-on energy store apparatus in a third position;

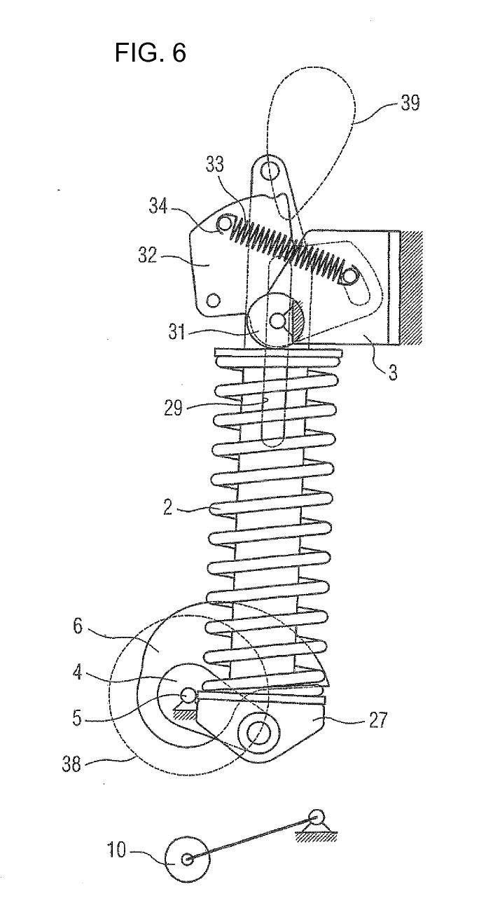

FIG. 6 shows a schematic illustration of the switch-on energy store apparatus in a fourth position;

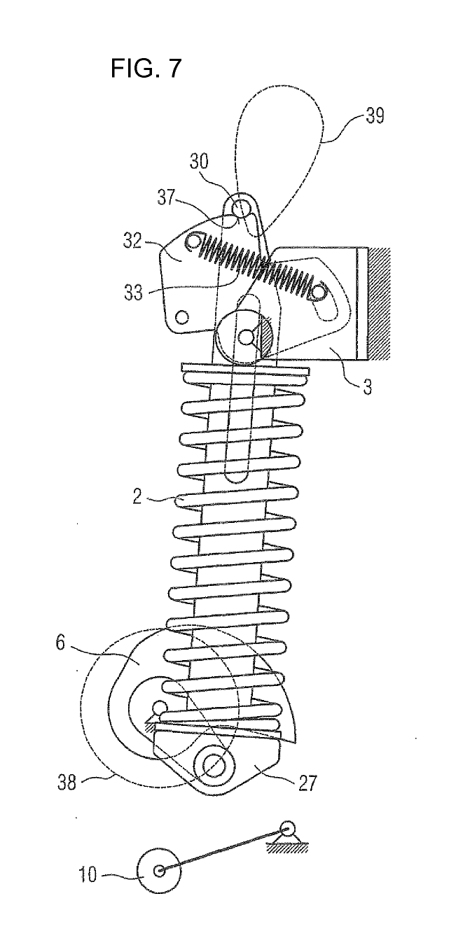

FIG. 7 shows a schematic illustration of the switch-on energy store apparatus in a fifth position;

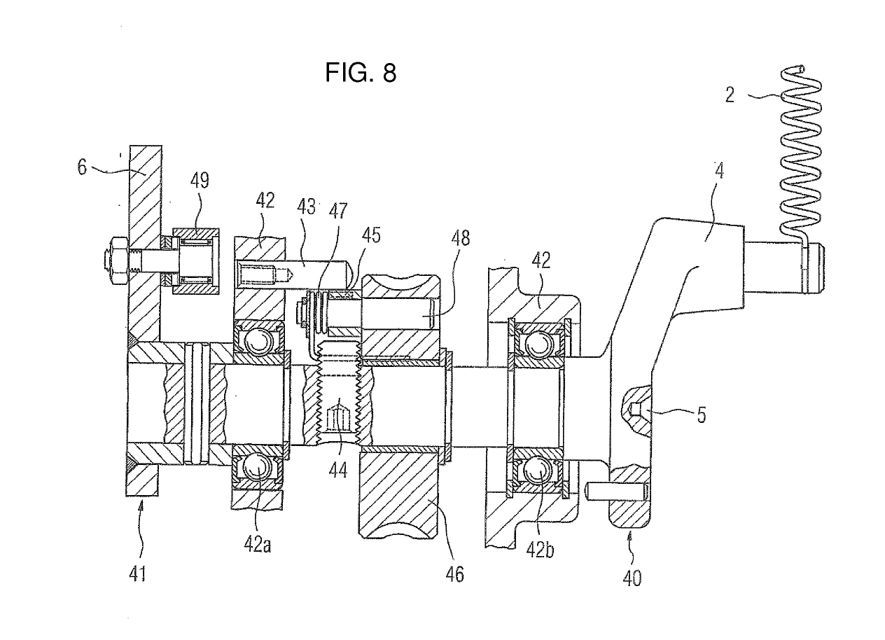

FIG. 8 shows a schematic side view of the tensioning apparatus;

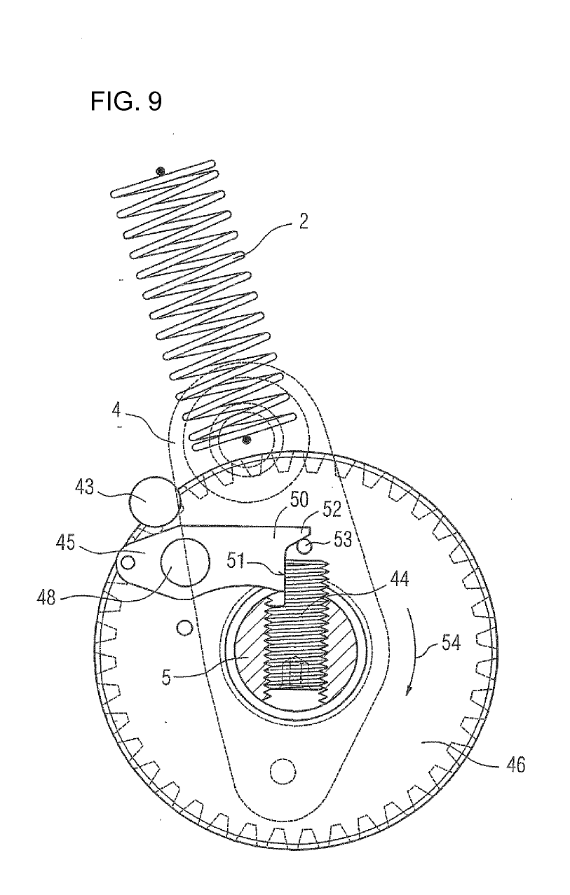

FIG. 9 shows a front view of the tensioning apparatus from FIG. 8 in a first position during the tensioning operation;

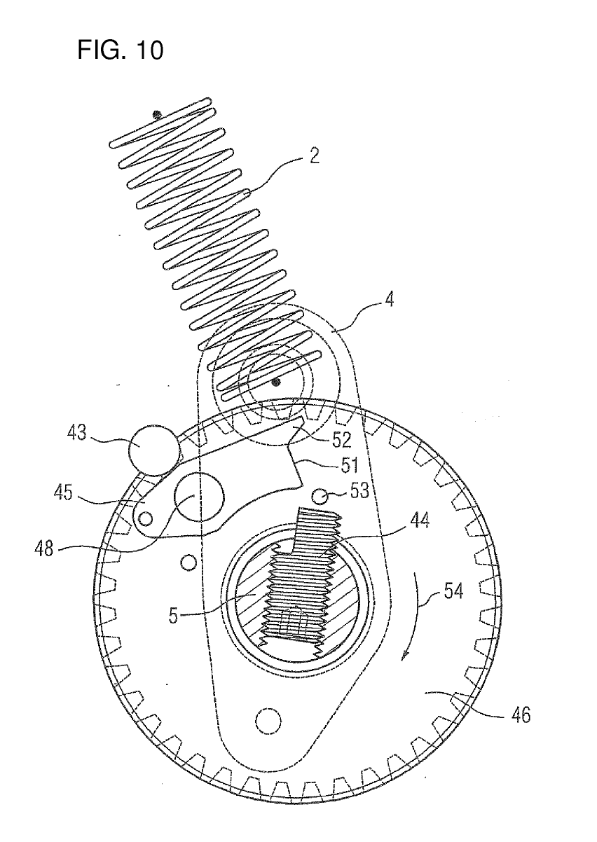

FIG. 10 shows a front view of the tensioning apparatus in a second position;

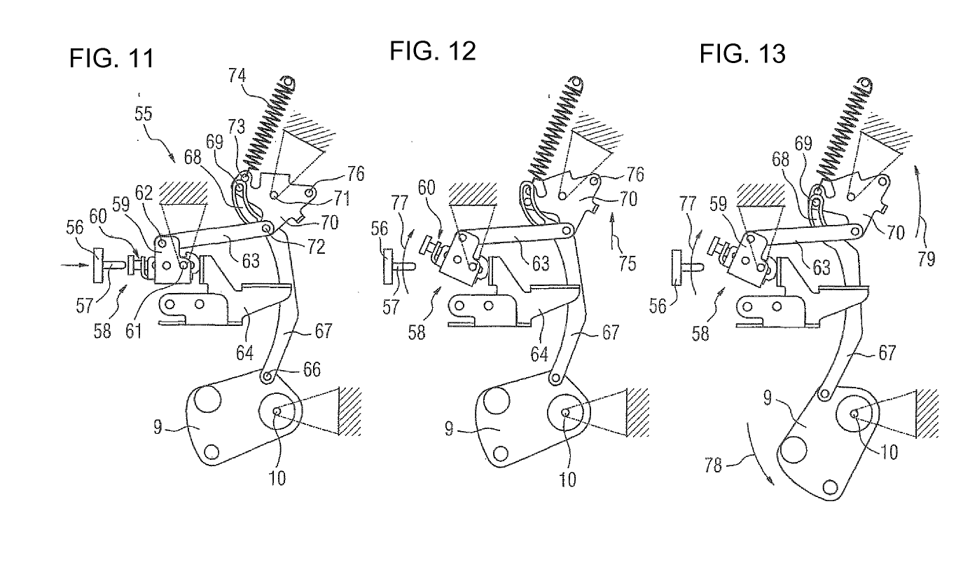

FIG. 11 shows a schematic illustration of an exemplary embodiment of the locking mechanism in an unlocking position;

FIG. 12 shows the locking mechanism shown in FIG. 11 in a locking position; and

FIG. 13 shows the locking mechanism shown in FIG. 11 in a further locking position.

FIG. 1 shows a schematic illustration of a circuit breaker 1 according to the invention. The circuit breaker 1 comprises a switch-on energy store 2, which is arranged on a fastening part 3 of the circuit breaker 1. The switch-on energy store 2 is connected to the cam disk 6 by means of an articulated connection at an eccentric 4 via a tensioning shaft 5. The cam disk 6 is mounted in such a way that it can rotate about a pivot 7 and bears with its outer face 8 against a cam element 9 of a switching shaft 10. The switching shaft 10 is mounted in such a way that it can rotate about a pivot 11 and comprises a second driver 12, which is connected in articulated fashion to a first end 13 of a switch-off energy store 14. A second end 15 of the switch-off energy store 14 is connected to a twin-armed lever 17, to whose first end 18 the switch-off energy store 14 is coupled in articulated fashion and which is mounted movably about a pivot 19. A second end 20 of the twin-armed lever 17 is in turn coupled in articulated fashion to a pole arrangement 21. The pole arrangement 21 comprises a first movable contact 22, which is connected in articulated fashion to the second end 20 of the twin-armed lever 17, and a second contact 23, which is arranged fixedly.

FIG. 1 illustrates the circuit breaker 1 in a switched-off position. The switch-on energy store 2 is located in a position in which energy for triggering a switching operation is stored. In this position of the switch-on energy store 2, the cam disk 6 bears against the cam element 9 of the switching shaft 10, the switch-off energy store 14 being relieved of tension and the twin-armed lever 17 being located in a position in which the first contact piece 22 is disconnected from the second contact 23.

FIG. 2 shows the circuit breaker in a closed switching position, in which the first contact 22 and the second contact 23 are connected to one another. As a result of a triggering mechanism (not illustrated) being triggered, the switch-on energy store 2 transmits the energy by means of the eccentric 4 and the tensioning shaft 5 to the cam disk 6, which performs a rotation in the counterclockwise direction about its pivot 7. When the can disk 6 rotates, the switching shaft 10 is moved, via the cam element 9, to a rotation in the counterclockwise direction about its pivot 11. The rotation of the switching shaft 10 results in a movement of the driver 12 in the counterclockwise direction, as a result of which the twin-armed lever 17, which is connected in articulated fashion to the switch-off energy store 14, is likewise rotated in the counterclockwise direction about its pivot 19. In this case, the first end 18 of the twin-armed lever 17 moves downwards and the second end 20 moves upwards. As a result of this movement, the first contact piece 22 is pressed against the second contact piece 23, and the contact of the pole mechanism 21 is closed. Furthermore, during the movement of the driver 12 the switch-off energy store 14 is tensioned. FIG. 2 shows the position of the switched-on circuit breaker 1, in which a kinematic chain comprising the switch shaft 10 and the switch-off energy store 14 are fixed virtually in an extended position, i.e. an axis from the first end 13 of the switch-off energy store 14 to the second end 15 of the switch-off energy store 14 is at an angle of virtually 180° with respect to an axis from the driver 12 to the pivot 11 of the switching shaft 10.

As a result of the arrangement of the kinematic chain comprising the switch shaft 10 and the switch-off energy store 14 virtually in an extended position, only a low torque, which is produced by the switch-off energy store 14, acts on the switching shaft 10, with the result that said switching shaft 10 can be fixed in the position illustrated in FIG. 2 by a simple catch mechanism (not illustrated).

When the switching shaft 10 is fixed, a renewed tensioning operation for the switch-on energy store 2 can take place by means of a drive apparatus, which is connected via a transmission to the tensioning shaft 5 and therefore to the cam disk 6 and the switch-on energy store 2. As a result of the drive, the cam disk 6 is caused to perform a further rotation in the counter-clockwise direction, the outer face 8 of the cam disk 6 no longer being in contact with the cam element 9 of the switching shaft 10. The switching shaft 10, which is fixed by the catch mechanism, remains in the position in FIG. 2, with the result that the contact pieces 22 and 23 remain in contact with one another. The drive at the same time brings about tensioning of the switch-on energy store 2 by means of the connection 5.

If the catch mechanism for fixing the switching shaft is released, the torque produced by the switch-off energy store 14 is sufficient for rotating the switching shaft 10, which is not in contact with the cam disk 6, in the clockwise direction about its pivot 11, a rotation of the twin-armed lever 17 in the clockwise direction being brought about by the spring force of the switch-off energy store, and the first contact piece 22 being disconnected from the second contact piece 23. The circuit breaker 1 is again located in a position, as illustrated in FIG. 1, with the switch-on energy store 2 tensioned and the contacts 22, 23 disconnected.

FIG. 3 shows a switch-on energy store apparatus with a spring element 2 as the switch-on energy store 2, which is connected at a first end 24 by means of a catch arrangement 25 to the fastening part 3 and at a second end 27 in articulated fashion to the eccentric 4. The eccentric 4 and the cam disk 6 are fixedly arranged on the tensioning shaft 5. A guide part 28 with a slot 29 and a stop element 30 is passed through the first end 24 of the switch-on energy store 2. The guide part 28 is rigidly connected to the second end 27 and is mounted on the fastening part 3 by means of a spindle 31, which extends through the slot 29. The catch arrangement 25 comprises a catch 32, which is likewise mounted rotatably on the spindle 31, and a spring 33, which is fastened at its first end 34 on the catch 32 and at its second end 35 on the fastening part 3. The dashed line 38 corresponds to the movement path of the second end 27 and the dashed line 39 corresponds to the movement path of the stop element 30 during a switching or tensioning operation of the switch-on energy store. The movement path 39, as a result of the kinematic arrangement of the system, is characterized by the fact that, during the movement of the stop element 30 from an upper to a lower dead center of the switch-on energy store, a different trajectory is covered than in the reverse movement, as a result of which the latching with the catch 32 is made possible.

In FIG. 3, the switch-on energy store is in a tensioned state, the spring element being under compressive strain. The second end 27 is at the upper reversal point of its movement trajectory 38, and the stop element 30 is close to the upper bend point of its trajectory 39, and the spindle 31 is located at the lower stop of the slot 29 of the guide part 28. The catch 32 is held in a first position by the tensile force of the spring 33.

If a switching operation is triggered, the energy stored in the switch-on energy store 2 is transmitted via the eccentric 4 and the tensioning shaft 5 to the cam disk 6 and as a result to the switching shaft 10. In the process, the second end 27 moves along the line 38 in the counterclockwise direction, and the stop element 30 moves on the line 39 in the clockwise direction.

FIG. 4 shows the switch-on energy store 2 with the catch mechanism in a position surely after the triggering of a switching operation, the switch-on energy store 2 having been partially relieved of tension. The energy of the switch-on energy store 2 results in the rotation of the cam disk 6 via the tensioning shaft 5 and therefore in a movement of the switch shaft 10. The second end 27 is in a 9 o'clock position on the line 38, while the stop element 30 has moved downwards on the line 39. The spindle 31 is located in a position close to the second end of the slot 29 relative to the slot 29 as a result of the movement of the guide part 28, which is connected to the second end 27.

FIG. 5 shows the switch-on energy store 2 in a completely untensioned state, in which the second end 27 and the stop element 30 have reached the lower reversal points of the respective lines 38 and 39. In this position, the spindle 31 is at the upper end of the slot 29. The stop element 30 bears against the catch 32 in a tensioning cutout 36. In this position, the stop element 30 begins to move the rotatably mounted catch 32 counter to the spring force of the spring 33 away from the fastening part 3, the spring 33 being tensioned in the process.

FIG. 6 shows the position of the switch-on energy store 2 and the catch mechanism directly after the switching operation of the circuit breaker. The cam disk 6 is not in contact with the switching shaft 10, and the switching shaft 10 and therefore the contacts of the circuit breaker are in a locked and switched-on position. As a result of the energy of the switch-on energy store 2 which has been partially converted into movement energy during the switching operation, the cam disk 6 and the eccentric 4 rotate beyond their reversal points, the guide part 28 moving upwards and the stop element 30 leaving the tensioning cutout 36 of the catch 32. At this point in time, the catch 32 is moved back into its first position by the tensile force of the spring 33. As a result of the continued rotation of the eccentric 4, the switch-on energy store 2 is partially tensioned, as a result of which the switch-on energy store 2 performs a return movement. This return movement is limited by the catch 32, which is moved back into its first position by the spring 33, as explained with reference to FIG. 7.

FIG. 7 shows the position of the switch-on energy store 2 and of the catch mechanism after the switching operation of the circuit breaker with the stop element 30 latched in. The stop element 30 engages in the checking cutout 37 of the catch 32 and is locked. As a result of this locking, a further return of the switch-on energy store 2 is reliably prevented. The circuit breaker can therefore immediately be switched off again and a new tensioning operation can take place for the switched-on energy store.

FIG. 8 shows a tensioning apparatus for the switch-on energy store 2 in a schematic side view. The apparatus comprises a tensioning shaft 5, at whose first end 40 the eccentric 4 is arranged. At the second end 41 of the tensioning shaft 5, the cam disk 6 is fixedly connected to the tensioning shaft 5. A stop element 43 is fixedly arranged on a housing part 42 of the tensioning apparatus, in which housing part the tensioning shaft 5 is mounted rotatably by means of ball bearings 42a, 42b. A driver 44, which interacts with a drive wheel 46 via a catch 45, is fixedly connected to the tensioning shaft 5. The catch 45 is in this case arranged rotatably on the drive wheel 46 by means of a spring element 47. The drive wheel 46 is the last drive wheel of a gear mechanism (not illustrated), for example of a worm gear, which can be driven by means of a crank handle drive or a motor drive. The switch-on energy store 2 is arranged in articulated fashion on the eccentric 4. A triggering stop 49 is provided as the stop for the tensioning apparatus after a tensioning operation, the triggering stop being capable of being triggered by means of a mechanism, which is described with reference to FIGS. 11 to 13, in order to carry out a switching operation of the circuit breaker when the switch-on energy store 2 is tensioned.

FIG. 9 shows a front view of the tensioning apparatus according to the invention in a position during the tensioning operation of the switch-on energy store. The catch 45 is in contact at its end 50 with the driver 44 via the contact face 51. A stop 52, which bears at a positioning pin 53 against the drive wheel 46, is formed at the end 50 of the catch 45. As a result of a rotation of the drive wheel 46 which is brought about via the drive, the tensioning shaft 5 and therefore the eccentric 4 are set into a rotation in the clockwise direction via the catch 45, which bears against the driver 44. As a result, the switch-on energy store 2, which is mounted in articulated fashion on the eccentric 4, is tensioned. In the position in FIG. 9, the eccentric 4 is in a position in which the switch-on energy store 2 is below its maximum compression spring tensioning. In order to produce a torque which is required for triggering a switching operation, the eccentric 4 needs to be rotated further into a position which deviates from this maximum extended position by a few degrees.

FIG. 10 illustrates the position of the catch 45 after a completely performed tensioning operation of the switch-on energy store 2. During the rotation of the drive wheel 46 in the clockwise direction, the catch 45 comes into contact with the stop element 43, as a result of which a rotation of the catch 45 about this spindle 48 in the counterclockwise direction is triggered, with the result that the contact face 51 no longer bears against the driver 44 and the catch is swiveled away from the driver 44. The tensioning shaft 5 in this position is decoupled from the drive wheel 46 and therefore from the drive. As a result of a further rotation of the drive wheel 46, no more force is therefore exerted on the cam disk or on the eccentric.

In the event of a switch-on operation, the triggering stop 49 is triggered, with the result that the energy stored in the switch-on energy store 2 is used for rotating the cam disk 6, which is connected to the tensioning shaft 5, and therefore for closing the movable contact of the circuit breaker. In this case, the tensioning shaft 5 and the parts connected to it rotate in the direction of the arrow 54 in FIG. 10 until the switch-on energy store 2 is completely relieved of tension. The drive wheel 46 with the catch 45 in this case remains in the position in FIG. 10. As a result, no energy is transmitted to the drive wheel and the drive during the switching operation. If a new tensioning operation is carried out after the switching operation, the drive wheel 46 is likewise moved in the direction of the arrow 54 via the drive. The catch is in this case deflected further on the stop element 43 and moves on it along until, as a result of the rotation of the drive wheel 46, the catch 45 is no longer in contact with the stop element 46 and is rotated in the direction of the tensioning shaft 5 as a result of the force exerted by the spring element 47, until the catch 45 bears against the positioning pin 53. The positioning pin 53 prevents the catch 45 from resting on the tensioning shaft 5 during the further rotational movement of the drive wheel 46. As a result of the further rotary movement, the catch 45 comes into contact with the driver 44, with the result that the drive wheel 46 and the tensioning shaft 5 are coupled again and the switch-on energy store 2 is tensioned again.

FIG. 11 shows an exemplary embodiment of a locking mechanism 55 in a schematic illustration. The locking mechanism 55 has a pushbutton 56, which bears with its pin extension 57 against a force transmission element 58. The force transmission element 58 has a guide frame 59, in which a displacement element 60 is guided movably in a linear movement direction. The guide frame 59 is held in such a way that it is capable of moving about a swivel bearing 61, which is fixed in position, and is connected to a swiveling lever 63 at a bearing 62.

The force transmission element 58, in the unlocking position shown in FIG. 11, bears with its longitudinally movable displacement element against a discharge triggering device 64, which, on actuation, i.e. as a result of a thrusting movement in the arrow direction shown being introduced into the discharge triggering device 64, releases a lock of the switch-on energy store 2 (not illustrated in the figures), as a result of which the triggering stop 49 described with reference to FIG. 8 is released, so that the switch-on energy store 2 is discharged.

The switch-on energy store 2 in the exemplary embodiment shown is mechanically coupled to the switching shaft 10 of the circuit breaker from FIG. 1. The introduction of a rotary movement into the switching shaft 10 moves the contacts of the circuit breaker from a contact position, in which the switching contacts of the switch bear against one another, into a disconnecting position, in which the contacts of the switch are disconnected from one another, or from the disconnecting position into the contact position, as already described with reference to FIGS. 1 and 2.

The switching shaft 10 is connected in articulated fashion to a swiveling drive lever 67 at the cam element 9 at a bearing 66. The swiveling drive lever 67 has a slot 68 at its end facing away from the bearing 66, into which slot 68 a driver pin 69 of an angle lever 70 extends, which is capable of moving about a pivot bearing 71, which is fixed in position. The angle lever 70 is connected in articulated fashion to the swiveling lever 63 at its bearing 72. At the restoring spring bearing 73, the angle lever 70 is also coupled to a restoring spring 74, which, in the position shown, holds the driver 69 of the angle lever 70 at the upper end of the slot 68. The upper limit of the slot 68 therefore forms a type of abutment.

FIG. 12 shows the locking mechanism shown in FIG. 11 in a locking position, in which the circuit breaker is displaced on a withdrawable part so as to disconnect contacts of a switch disconnector. As a deviation from this, the angle lever 70 is coupled to the drive shaft of a separate switch disconnector or secondary switch (not shown). It is of course also possible for both variants to be realized jointly in the context of the invention.

The movement, which is necessarily introduced, for example for the purpose of displacing the switch on the withdrawable-part guide, is introduced into the angle lever 70 via a lever mechanism (not shown in FIG. 12), which angle lever 70 then moves in the arrow direction 75 shown. The lever mechanism is linked to a bearing 76 of the angle lever 70, for example. As a result of the connection between the angle lever 70 and the force transmission element 58 via the swiveling lever 63, swiveling of the force transmission element 58 occurs in a direction indicated by the arrow 77. The movement direction of the displacement element 60 of the force transmission element 58 is therefore aligned at an angle to the movement direction of the pushbutton 56, in which the pin extension 57 of the pushbutton 56 extends. In this way, the switch-on movement of the pushbutton 56 can no longer be transmitted to the discharge triggering device 64, so that discharging of the switch-on energy store 2 is made impossible.

FIG. 13 shows the locking mechanism shown in FIG. 11 in a further unlocking position, the unlocking position having been brought about by a movement of the switching shaft 10. A rotation of the switching shaft 10 brings about a rotation of the cam element 9 in the arrow direction 78 shown and therefore a downward displacement of the swiveling drive lever 67. The driver 69 of the angle lever 70 which protrudes into the slot 68 of the swiveling drive lever 67 is in this way likewise moved downwards, with the result that the angle lever 70 is swiveled in the arrow direction 79 shown. As a result of the lever connection 63 between the guide frame 59 and the angle lever 70, the force transmission element 58 is likewise swiveled in the arrow direction 77. As a result of the rotation of the switching shaft 10, therefore not only the switching contacts of the switch poles of the switch but furthermore also a locking position of the locking mechanism are brought about, in which position the tension of the switch-on energy store 2 (not shown) is prevented from being relieved by actuation of the pushbutton 56.

A switch-on readiness indicator (not illustrated in the figures) can be arranged on the locking mechanism 55, for example on the guide frame 58. As a result of the connection between such an indicator unit and the guide frame 58, the state of the circuit breaker can be indicated directly by the different positions of the guide frame 58.

### LIST OF REFERENCE SYMBOLS

1 Circuit breaker
2 Switch-on energy store
3 Fastening part
4 Eccentric
5 Tensioning shaft
6 Cam disk
7 Pivot
8 Outer face
9 Cam element
10 Switching shaft
11 Pivot
12 Driver
13 First end
14 Switch-off energy store
15 Second end
16 Actuating mechanism
17 Twin-armed lever
18 First end
19 Pivot
20 Second end
21 Pole mechanism
22 First contact
23 Second contact
24 First end of switch-on energy store
25 Catch arrangement
27 Second end
28 Guide part
29 Slot
30 Stop element
31 Spindle
32 Catch
33 Spring
34 First end of spring
35 Second end of spring
36 Tensioning cutout
37 Checking cutout
38 Movement path of second end
39 Movement path of stop element
40 First end
41 Second end
42 Housing part
43 Fixed stop element
44 Driver
45 Catch
46 Drive wheel
47 Spring element
48 Spindle
49 Triggering stop
50 End of catch
51 Contact face
52 Stop
53 Positioning pin
54 Arrow
55 Locking mechanism
56 Pushbutton 56
57 Pin extension
58 Force transmission element
59 Guide frame
60 Displacement element
61 Swivel bearing
62 Bearing
63 Swiveling lever
64 Discharge triggering device
66 Bearing
67 Swiveling drive lever
68 Slot
69 Driver pin
70 Angle lever
71 Pivot bearing 71
72 Bearing 72
73 Restoring spring bearing
74 Restoring spring
75 Arrow
76 Bearing
77 Arrow
78 Arrow
79 Arrow

1-25. (canceled)

26. A circuit breaker, comprising:
at least one pole arrangement having a movable contact piece;
a pivotally mounted twin-armed lever for opening and closing said movable contact, said lever having a first end and a second end connected to said contact piece;
a switch-on energy storage device and a cam disk coupled to said switch-on energy storage device;
a pivotally mounted switching shaft forming an actuating element controlled by said cam disk and coupling said cam disk to said first end of said lever; and
at least one switch-off energy storage device connected between said switching shaft and said first end of said twin-armed lever.

27. The circuit breaker according to claim 26, wherein said pole arrangement is one of a plurality in a multi-pole pole arrangement, said switching shaft extends over the entire said multi-pole arrangement and has a driver for each movable contact, and wherein a first end of the respective said switch-off energy storage device is arranged on said driver in articulated fashion.

28. The circuit breaker according to claim 27, wherein said switch-off energy storage device has a second end articulated at said first end of said twin-armed lever.

29. The circuit breaker according to claim 26, wherein said switch-off energy storage device comprises a spring element.

30. The circuit breaker according to claim 26, wherein said switch-on energy storage device comprises a spring element having a first end mounted on a housing part and a second end coupled to said cam disk via a tensioning shaft.

31. The circuit breaker according to claim 26, wherein said switch-on energy storage device has a first end and a second end connected to an eccentric of a tensioning apparatus for said switch-on energy storage device, wherein return movement-limiting means are disposed to interact with said eccentric, and said return movement-limiting means include a catch mechanism disposed at said first end of said switch-on energy storage device.

32. The circuit breaker according to claim 31, wherein said return movement-limiting means comprise a guide part, disposed to trigger said catch mechanism, said guide part movably mounting said first end of said switch-on energy storage device on a fixed spindle by way of a slot formed in the guide part, and wherein said guide part is connected to said second end of said switch-on energy storage device.

33. The circuit breaker according to claim 32, wherein said catch mechanism includes a catch pivotally mounted about said fixed spindle between a first position and a second position, and a spring element acting on said catch.

34. The circuit breaker according to claim 33, which comprises a fastening element holding said fixed spindle and said spring element.

35. The circuit breaker according to claim 33, which comprises a stop element mounted to said guide part, said stop element interacting with a tensioning cutout formed in said catch.

36. The circuit breaker according to claim 35, wherein said catch is formed with an arresting cutout.

37. The circuit breaker according to claim 31, wherein said tensioning apparatus for said switch-on energy storage device comprises:
a tensioning shaft and a drive wheel for rotating said tensioning shaft for tensioning said switch-on energy storage device, said tensioning shaft being fixedly connected in each case to an eccentric and to a cam disk;
a triggering stop; and
a coupling clutch coupling said drive wheel to said tensioning shaft, wherein said coupling clutch is a catch configuration.

38. The circuit breaker according to claim 37, wherein:
said catch configuration includes a catch rotatably mounted on said drive wheel; and
a fixed stop element for controlling said catch.

39. The circuit breaker according to claim 38, wherein said fixed stop element is disposed such that, when said switch-on energy storage device is tensioned, said catch releases said tensioning shaft.

40. The circuit breaker according to claim 39, wherein said catch configuration includes a driver fixedly connected to said tensioning shaft and disposed to interact with said catch.

41. The circuit breaker according to claim 40, wherein said catch configuration includes a spring element.

42. The circuit breaker according to claim 41, wherein a positioning pin is mounted on said drive wheel.

43. The circuit breaker according to claim 26, which comprises a locking mechanism for preventing a discharge of said switch-on energy storage device with:
a pushbutton coupled, in an unlocking position of said locking mechanism, by way of a force transmission element to a discharge triggering device for discharging said switch-on energy storage device via an interlocking connection, wherein a switch-on movement of said pushbutton is introduced into said discharge triggering device for relieving a tension of said switch-on energy storage device via said force transmission element;
said force transmission element being connected to interlocking-connection interruption means configured to move said locking mechanism into a locking position, in which the interlocking connection between said pushbutton and said discharge triggering device is canceled;
said pushbutton and said force transmission element being movably guided in the unlocking position in a common longitudinal direction, to thereby introduce a thrusting movement of said pushbutton into said switch-on triggering device via a longitudinal movement of said force transmission element;
said force transmission element being pivotally mounted such that, in a locking position, a movement direction of said force transmission element is skewed at an angle to the thrusting movement of said pushbutton; and
said interlocking-connection interruption means being coupled to at least on of said switching shaft of said circuit breaker and/or to a secondary switch.

44. The circuit breaker according to claim 43, wherein said interlocking-connection interruption means include an angle lever, said angle lever is articulated on a positionally fixed pivot and includes a restoring bearing coupled to a restoring spring and a connecting bearing coupled to said force transmission element by way of a swiveling lever.

45. The circuit breaker according to claim 44, wherein said angle lever is coupled to a switching shaft of the secondary switch by way of lever kinematics such that, if the secondary switch is in a disconnecting position, said angle lever is swiveled counter to a spring force of said restoring spring and said force transmission element is moved from the unlocking position into the locking position.

46. The circuit breaker according to claim 44, wherein said angle lever is coupled to a withdrawable-part lock of a withdrawable part by way of lever kinematics such that, if the switch is displaced on the withdrawable part, said angle lever is swiveled counter to the spring force of said restoring spring and said force transmission element is moved from the unlocking position into the locking position.

47. The circuit breaker according to claim 44, wherein said angle lever has a driver pin disposed to extend in a slot of a drive lever, said drive lever has an end remote from said slot fastened on a cam element of said switching shaft, wherein, in a switch-position of said switching shaft, said angle lever is swiveled so as to cancel the interlocking connection between said pushbutton and said discharge triggering device.

48. The circuit breaker according to claim 43, wherein said locking mechanism is switchable between a locking position, in which the triggering of a switch-on operation with said contacts of the circuit breaker coming into contact with one another is prevented, and an unlocking position, in which the triggering of the switch-on operation is enabled, and said locking mechanism is linked to a switch-on readiness indicator, and said switch-on readiness indicator is disposed on said switch to be perceived visually.

49. The switch according to claim 48, wherein said switch-on readiness indicator is a mechanical indicator.

50. The switch according to claim 48, wherein said switch-on readiness indicator is an optical indicator.
